(19) United States
(12) Patent Application Publication
(10) Pub. No.: US 2007/0223447 A1
(43) Pub. Date: Sep. 27, 2007

(54) Gateway device and control method thereof

(76) Inventors: Shiro Saito, Tokyo (JP); Kazuhiko Seki, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 11/385,563

(22) Filed: Mar. 21, 2006

(51) Int. Cl. H04L 12/28

(52) U.S. Cl. 370/351

(57) ABSTRACT

A gateway device which judges whether a first terminal device and a second terminal device belong to a same network when a connection request from the first terminal device to the second terminal device is accepted, and performs control such that a packet transmitted from one of the first terminal device and the second terminal device can be directly received by the other when both of these terminal devices belong to a same network.

### BACKGROUND

The present invention relates to a technology for providing a communication service, such as phone calls, using an Internet protocol network, and more particularly to a technology to improve a gateway device for performing such processing as the establishment and disconnection of a session and routing.

Recently a technology to perform voice communication using IP (VoIP) is receiving attention, and the use of “IP telephones”, which communicates based on VoIP, have started to spread. In IP telephones, analog voice signals corresponding to the voices of a user are converted into digital data, a predetermined compression processing is performed and the data is packetized, and is sent to the destination via the network. At the call destination, the analog voice signals are restored based on the received packet, and voices are output. A prior art on IP telephones is disclosed in Japanese Patent Application Laid-Open No. 2001-177577, for example.

When data is transmitted and received using IP, path selection routing must be performed so that the packet storing the data is sent to the correct destination. A router is a device which performs routing. The router performs routing IP packets based on the IP address, and at the same time IP packet is encapsulated in a frame in the MAC layer (data link layer), and the IP packet is transferred to the next equipment (another router or target equipment) based on the MAC address.

### SUMMARY

An IP telephone terminal, which does not know the IP address of the call destination terminal, normally sends a packet to a router specified as the default gateway (hereafter called “default GW”), and requests the start of the session.

When the session start request is received from the IP telephone terminal, the default GW establishes the session between the IP telephone terminal and the call destination terminal, and routes packets which are sent from the IP telephone terminal or the call destination terminal to implement conversation.

Here the default GW disposed on a local IP network, such as an extension line, normally functions as a “call stateful” GW which manages various state information of all transactions during session execution, in order to implement various functions, such as incoming representation for the session start request from an external network.

In this case, the default GW performs routing processing for all the packets to be exchanged in each session while managing all the established sessions. This situation where a lot of session management and routing processings must be performed is a very large burden on the default GW, and is a factor to drop the number of sessions that can be simultaneously established in a predetermined specification.

With the foregoing in view, it is an object of the present invention to provide a technology to improve the performance of the gateway by decreasing the load on the default GW disposed on a local IP network, and increasing the number of sessions that can be simultaneously established.

The gateway device of the present invention comprises means for judging whether a first terminal device and a second terminal device are connected to a same network, as an operation mode for the case when a session start request from the first terminal device to the second terminal device is accepted; performing routing of packets transmitted or received between both terminal devices when they are not connected to a same network; and performing control such that packets are directly transmitted or received between both terminal devices when they are connected to a same network, so that routing related to the session is not generated in this gateway device.

The gateway device of the present invention manages information of the session between the first terminal device and second terminal device in the gateway device when the session start request from the first terminal device to the second terminal device is accepted.

When the first terminal device and second terminal device are connected to a same network, packets directly transmitted or received between the terminal devices include at least one of a voice packet and a packet related the session.

The gateway device of the present invention establishes the session between the first terminal device and second terminal device via the gateway device when a session start request from the first terminal device to second terminal device is accepted.

The gateway device of the present invention performs control such that a direct session is established between the first terminal device and second terminal device without establishing a session via the gateway device when both terminal devices are connected to a same network.

A method of controlling a gateway device according to the present invention, comprises the steps of: accepting a session start request from a first terminal device to a second terminal device; judging whether the first terminal device and the second terminal device are connected to a same network; routing packets transmitted or received between the first terminal device and second terminal device when both terminal devices are not connected to a same network; and performing control such that packets transmitted from one of the first terminal device and the second terminal device can be directly received by the first terminal device or the second terminal device when both terminal device are connected to a same network, so that routing related to the session is not generated.

The computer program product according to the present invention comprises a computer program for causing a gateway device to execute the control method of the present invention. The computer program for having a gateway device execute the control method of the present invention can be installed or loaded into the gateway device via various recording media, such as CD-ROM, magnetic disk and semiconductor memory, or a communication network.

In the present description, one function may be implemented by two or more physical means, or two or more functions may be implemented by one physical means.

According to the present invention, a technology for improving the performance of a gateway can be provided by decreasing the load on the default GW disposed on a local IP network, and increasing the number of sessions that can be simultaneously established.

### DESCRIPTION OF THE DRAWINGS

FIG. 1 is a block diagram depicting the configuration of the entire system of the present invention;

FIG. 2 is a functional block diagram of the IP telephone according to the present invention;

FIG. 3A-3B are functional block diagrams of the default GW according to the present invention;

FIG. 4 shows a sequence when a session extends over a plurality of IP networks;

FIG. 5 shows a sequence when a session extends over a plurality of IP networks;

FIG. 6 shows an IP address and MAC address which are set in each packet when a session extends over a plurality of IP networks;

FIG. 7 shows a sequence in the first example and second example when the session is a session in a same IP network;

FIG. 8 shows a sequence in the first example when the session is a session in a same IP network;

FIG. 9 shows an IP address and MAC address which are set in each packet of the first example when the session is a session in a same IP network;

FIG. 10 shows an example of a sequence in the second example when the session is a session in a same IP network;

FIG. 11 shows a sequence in a third example when the session is a session in a same IP network; and

FIG. 12 shows a sequence in a third example when the session is a session in a same IP network.

### DETAILED DESCRIPTION

(System Configuration)

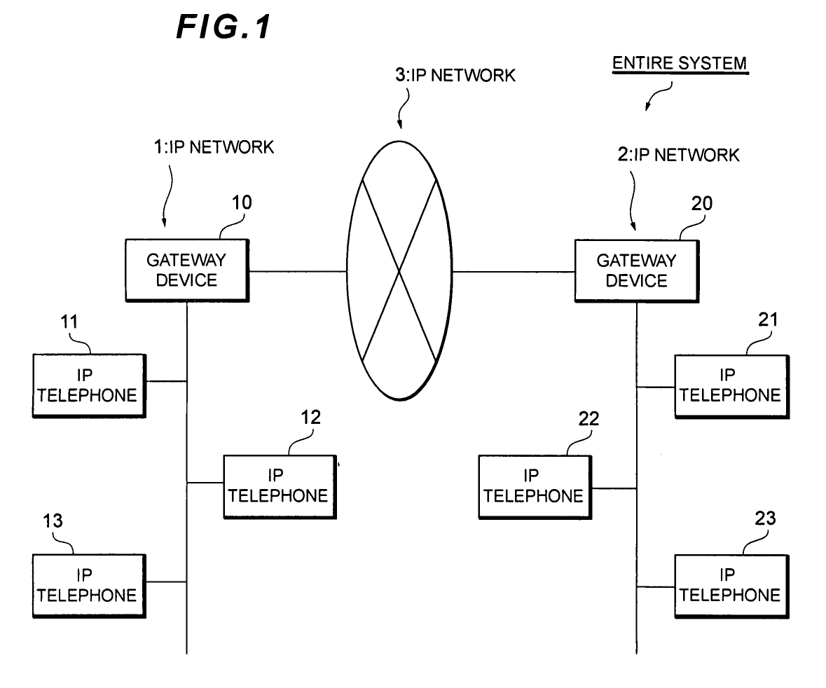

Embodiments of the present invention will now be described with reference to the drawings. FIG. 1 is a block diagram depicting the general configuration of the system according to the present invention.

As FIG. 1 shows, the entire system includes a plurality of IP networks (IP network 1, IP network 2, IP network 3, etc.). Each IP network may be a LAN, dedicated IP network, or Internet, for example.

The gateway device 10 (GW 10), IP telephone 11, IP telephone 12 and other are connected to the IP network 1. And the gateway device 20 (GW 20), IP telephone 21 and other are connected to the IP network 2.

The IP telephone 11 at least has the normal functions of a general IP telephone, and can be structured as a dedicated IP telephone terminal, for example, or as a combination of a general telephone and a terminal connection device (TA device) for executing each of the above processings, or a personal computer having the necessary input/output interfaces, with an IP telephone module mounted.

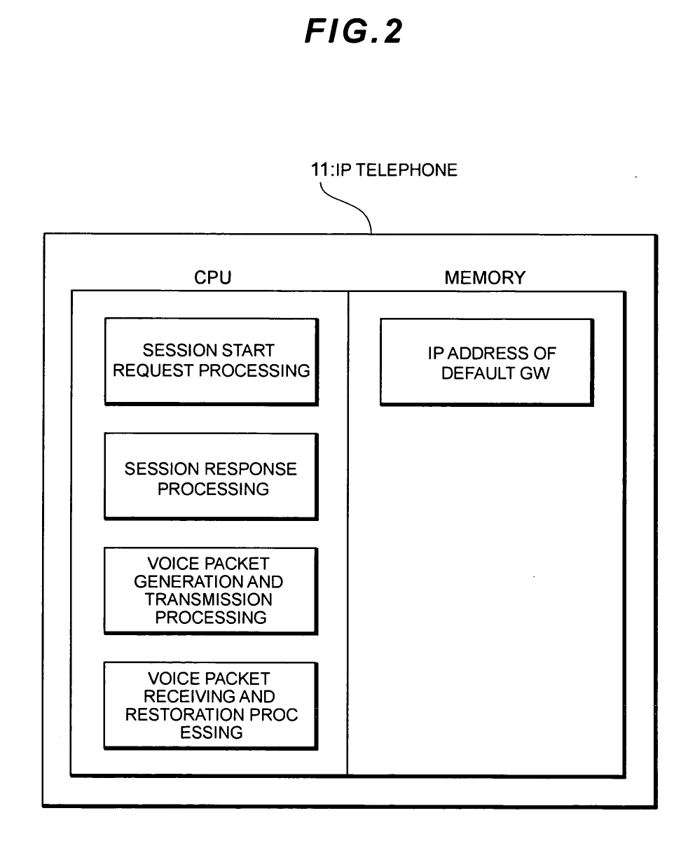

FIG. 2 shows functional block diagram of an IP telephone, using the IP telephone 11 to be connected to the IP network 1 as an example. As FIG. 2 shows, the IP telephone 11 stores the IP address of GW 10, which is a default gateway device of the IP network 1, in the storage means thereof.

When a telephone number of the call destination is input from a user, the IP telephone 11 sends an IP packet storing the telephone number as the data to GW 10, and executes processing for requesting to start a session, processing for responding to the establishment and disconnection of a session, processing for converting the voice, which is input from the user, into digital data, and sending it as voice packets, and processing for receiving voice packets to the IP telephone 11 itself, and restoring the voice packets to analog voice signals, and outputting them.

The GW 10 at least has the normal functions of a general gateway device, and can be structured as a dedicated gateway device, or can be implemented by an information processing device having a general configuration, including control means (CPU), input/output means and storage means, executing the gateway device construction programs including the programs of the present invention.

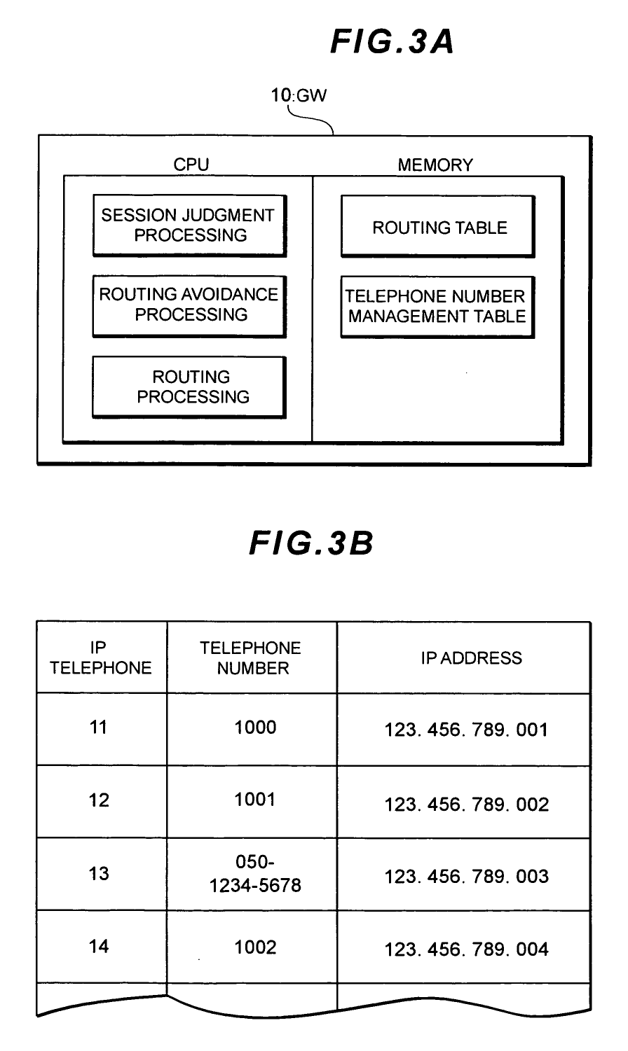

FIG. 3A shows a functional block diagram of the gateway device, using the GW 10 as an example. As FIG. 3A shows, the GW 10 stores a routing table for deciding the IP network where the IP telephone to receive the packets exists, or deciding the network on the path for reaching that IP telephone, out of the plurality of IP network connected to the GW 10 itself, and a telephone number management table where the telephone number of each IP connected to the IP network 1 and the IP address are corresponded to each other, in the storage means thereof. FIG. 3B shows an example of the telephone number management table. As this example shows, the telephone number to be registered in the telephone number management table may be either an extension number or regular telephone number.

The GW 10 comprises operation modes to execute processing for judging whether the session is a session in the IP network 1 (session judgment processing), which is an operation mode when a session start request is accepted from an IP telephone, processing for controlling such that packets are directly transmitted/received between IP telephones when the session is a session in the IP network, so that routing processing of this session is not generated in GW 10 (routing avoidance processing), and processing for inquiring the IP address of the call destination terminal to a predetermined location server, deciding the corresponding GW by referring to the routing table, and transferring the packets when this session is not the session in the IP network 1 (routing processing).

Now the sequence of establishing a session between IP telephones and performing conversation in the above operation modes will be described. The protocol on session establishment can be decided according to the design, but in the present embodiment it is assumed that SIP (Session Initiation Protocol) or a protocol conforming to this is used as a rule. For the steps in each sequence, the order thereof can be freely changed, or parallel execution is possible within a range where no inconsistency is generated in the processing contents.

(Case When a Session Extends over a Plurality of IP Networks)

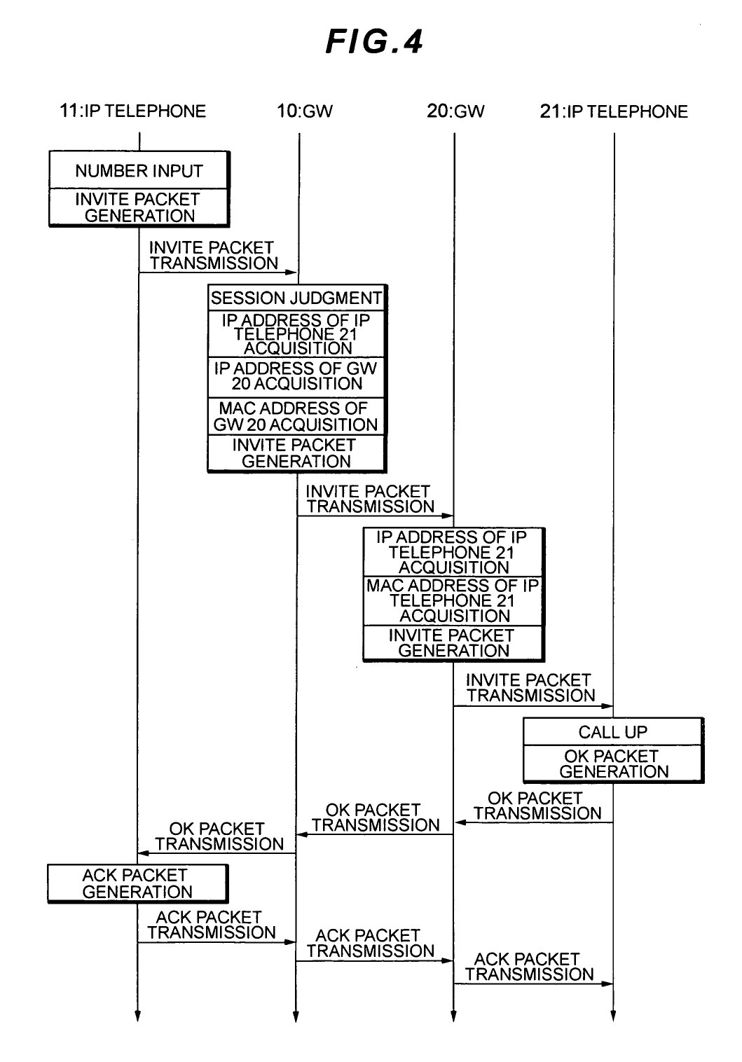

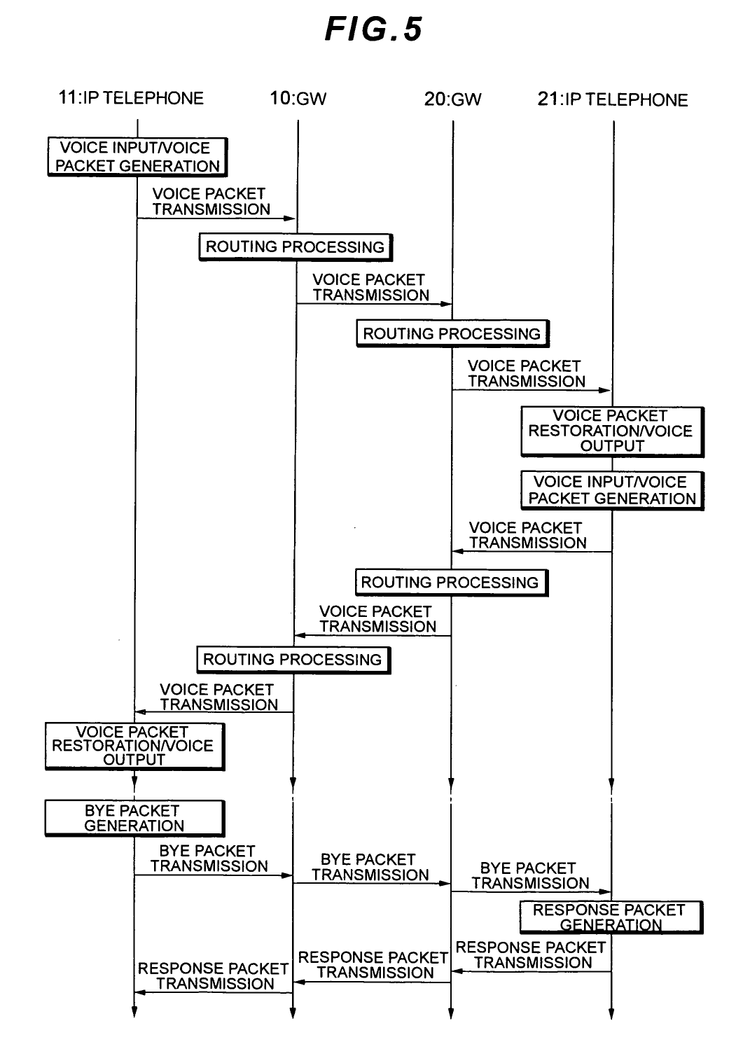

First the sequence when a session extends over a plurality of IP networks will be described using the case of calling from the IP telephone 11 to IP telephone 21 as an example (see FIG. 4 and FIG. 5). In this sequence, GW 10 functions as a call stateful GW, and stores and manages the state information of all transactions on the session from start to end and the state of each IP telephone.

The user inputs the telephone number of the IP telephone 21, which is a call destination, to the IP telephone 11.

Receiving this, the IP telephone 11 generates a packet to indicate a session start request for setting the IP address of GW 10 as the destination IP, and storing the telephone number of the IP telephone 21 as data (hereafter called “INVITE packet”).

Then the IP telephone 11 sets the MAC address of the GW 10 to the destination MAC, and sends the INVITE packet to the GW 10. The IP telephone 11 can acquire the MAC address of the GW 10 by referring to the ARP (Address Resolution Protocol) table where the IP address and MAC address to be stored in the local terminal are corresponded. If the MAC address of GW 10 is not registered in the ARP table, an ARP request packet is sent to the IP network 1, where the IP telephone 11 and GW 10 are connected, based on the IP address of the GW 10 registered in the local terminal, and the MAC address of GW 10 can be acquired as the response thereof.

When the INVITE packet is received from the IP telephone 11, the GW 10 judges whether this session is a session in the IP network 1, that is whether the IP telephone 21, which is the call destination, is connected to a same IP network as the IP telephone 11. The judgment method is such that, for example, if the telephone number of the IP telephone 21 extracted from the INVITE packet is registered in the telephone number management table, it is judged that the IP telephone 21 and the IP telephone 11 are connected to a same network.

Here the IP telephone 21 is connected to IP network 2, not IP network 1, so the IP telephone 21 is not registered in the telephone number management table of GW 10. Therefore GW 10 judges that the IP telephone 21 is not connected to a same network as the IP telephone 11.

In this case, the GW 10 inquires the IP address of the IP telephone 21 to the location server or ENUM (Electronic NUMbering) server (not illustrated), based on the telephone number of the IP 21 extracted from the INVITE packet.

When the IP address of the IP telephone 21 is acquired from the location server, the GW 10 refers to the routing table based on this IP address, and acquires the IP address of the GW 20, which is the default GW of the IP network 2 to which the IP telephone 21 is connected.

Then the GW 10 refers to its own ARP table and acquires the MAC address of the GW 20. If the MAC address of the GW 20 is not registered in the ARP table, the GW 10 sends an ARP request packet to the IP network 3 to which the GW 10 and GW 20 are connected, based on the IP address of the GW 20, and acquires the MAC address of the GW 20 as the response.

Then the GW 10 sets the IP address of the IP telephone 21 to the destination IP and generates the INVITE packet, and sets the MAC address of the GW 20 to the destination MAC, and sends the INVITE packet to the GW 20.

When the INVITE packet is received from the GW 10, the GW 20 extracts the destination IP of this INVITE packet, and acquires the IP address of the IP telephone 21.

Then the GW 20 refers to its own ARP table and acquires the MAC address of the IP telephone 21. If the MAC address of the IP telephone 21 is not registered in the ARP table, the GW 20 sends an ARP request packet to the IP network 2 to which the GW 20 and IP telephone 21 are connected based on the IP address of the IP telephone 21, and acquires the MAC address of the IP telephone 21 as the response thereof.

Then the GW 20 sets the MAC address of the IP telephone 21 to the destination MAC and sends the INVITE packet to the IP telephone 21.

When the INVITE packet is received from the GW 20, the IP telephone 21 calls up the user by ringing a bell, for example. When the user answers the call up, the IP telephone 21 sets the IP address of the IP telephone 11 to the destination IP, generates a packet to indicate that the call up succeeded (hereafter called the “OK packet”), sets the MAC address of the GW 20 to the destination MAC, and sends the OK packet to the GW 20. The IP telephone 21 can know the MAC address of the GW 20 and the IP address of the IP telephone 11 as the transmission source MAC address and transmission source IP address of the received INVITE packet.

When the OK packet is received, the GW 20 transfers this to the GW 10. When the OK packet is received, the GW 10 transfers it to the IP telephone 11.

When the OK packet is received from the GW 10, the IP telephone 11 sets the IP address of the IP telephone 21 to the destination IP, generates a response packet which indicates receiving the OK packet (hereafter called the “ACK packet”), sets the MAC address of the GW 10 to the destination MAC, and sends the ACK packet to the GW 10. The IP telephone 11 can know the IP address of the IP telephone 11 as the transmission source IP address of the received OK packet.

When the ACK packet is received, the GW 10 transfers this to the GW 20. Also when the ACK packet is received, the GW 20 transfers this to the IP telephone 21.

By the above sequence, the session is established between the IP telephone 11 and IP telephone 21 via the GW 10 and GW 20.

After the session is established, voice packets are transmitted/received between the IP telephones, and conversation is performed.

For example, the IP telephone 11 converts the voice signals corresponding to the voice spoken by the user into digital data, sets the IP address of the IP telephone 21 to the destination IP and generates voice packets, and sets the MAC address of the GW 10 to the destination MAC, and sends the voice packets to the GW 10.

In this case, when the voice packets are received, the GW 10 transfer them to GW 20. When the voice packets are received, the GW 20 transfer them to the IP telephone 21.

When the voice packets are received from the GW 20, the IP telephone 21 adjusts the restoring sequence based on the time stamp and the sequence number of the packet header, restores the digital data in the voice packets to analog voice signals, and outputs them.

The sequence when the voice packets are sent from the IP telephone 21 to the IP telephone 11 is also the same.

The session is ended (disconnected) by one IP telephone sending a packet to indicate the end of the session (hereafter called the “BYE packet”) to the remote side via the GW 10 and GW 20, and receiving the response packet to the BYE packet from the remote side via the GW 20 and GW 10.

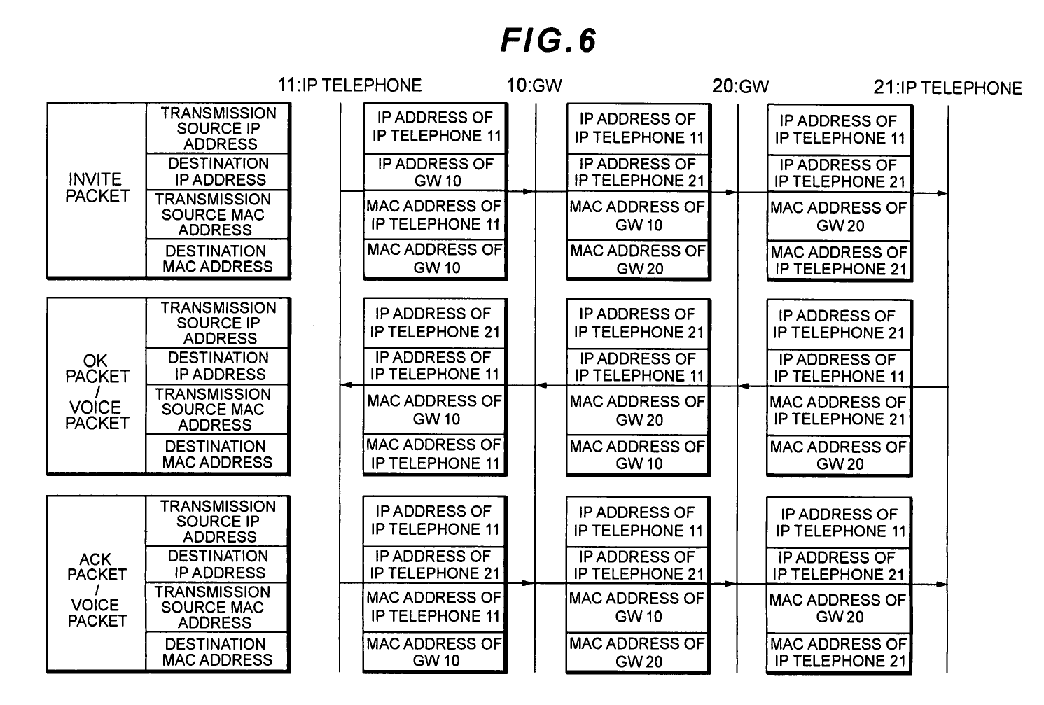

FIG. 6 shows the IP address and MAC address to be set for each INVITE packet, OK packet, ACK packet and voice packet to be transmitted/received in the above sequence.

In the case of a session where the session extends over a plurality of IP networks, as described above, all of the voice packets and the packets on the session (so called message packets, such as an INVITE packet, OK packet, ACK packet and BYE packet) are routed by the GW 10, so the GW 10 can function as a call stateful GW which always intervenes from the start to end of the session. Therefore the GW 10 can know the presence of each IP telephone and talking time, and implement various functions including incoming representation (e.g. if a session start request to the IP telephone 11 arrives from the outside when a session between the IP telephone 11 and IP telephone 12 is established, the response to indicate that a session is already established is returned to this start request, or the request is received by switching to another IP telephone 12).

(When Session is a Session Within a Same IP Network)

Now the sequence when the session is a session within a same IP network will be described using the case of calling from the IP telephone 11 to the IP telephone 12 as an example.

### FIRST EXAMPLE

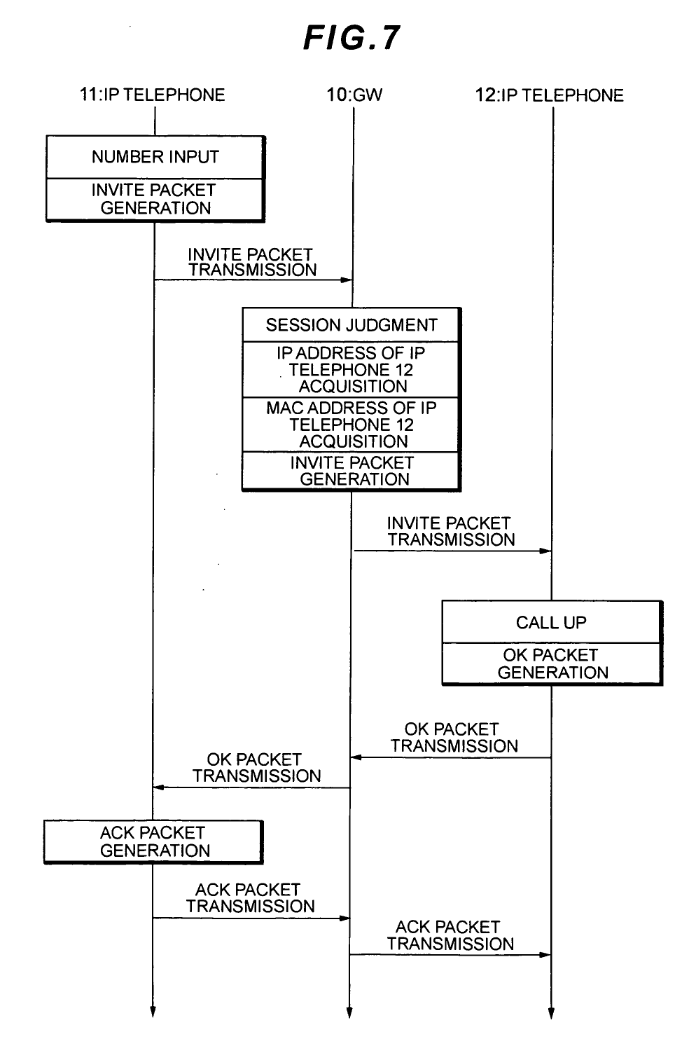

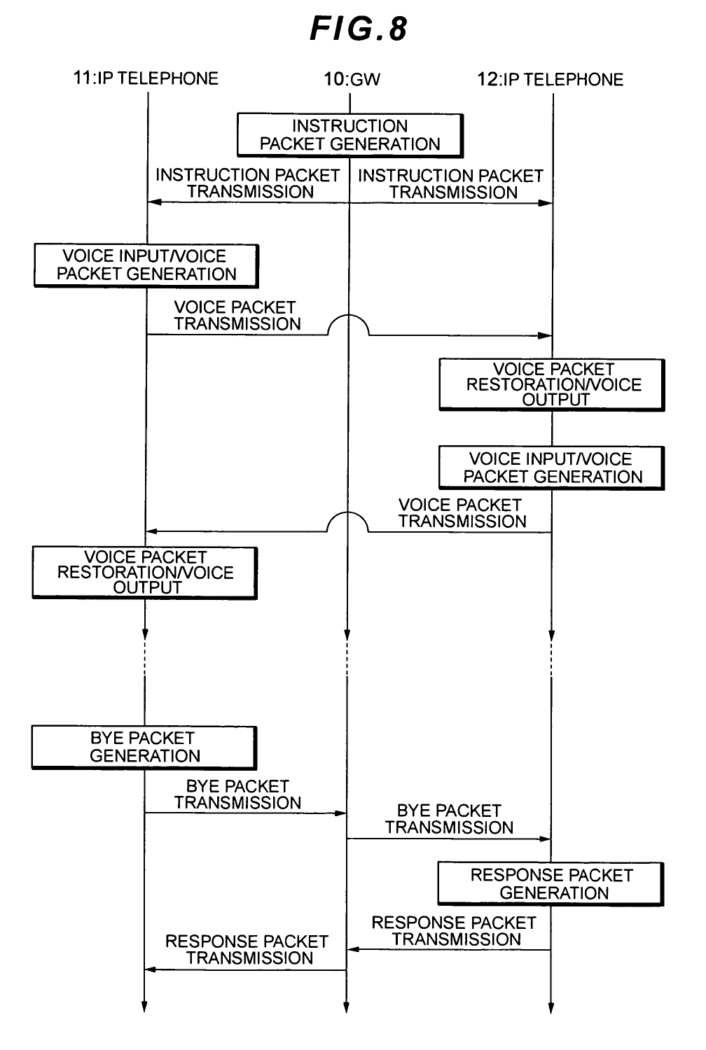

A sequence when a session is established via the GW 10, then voice packets are directly transmitted and received between the terminal devices without GW 10, but packets on the session are transmitted and received via GW 10, will be described as a first example (see FIG. 7 and FIG. 8).

The user inputs the telephone number of the IP telephone 12, which is the call destination, to the IP telephone 11.

Receiving this, the IP telephone 11 sets the IP address of the GW 10 as the destination IP, and generates the INVITE packet for storing the telephone number of the IP telephone 12 as data.

Then the IP telephone 11 sets the MAC address of the GW 10 to the destination MAC, and sends the INVITE packet to the GW 10.

When the INVITE packet is received from the IP telephone 11, the GW 10 judges whether this session is a session within the IP network 1, that is whether the IP telephone 12 at the call destination is connected to the same IP network of the IP telephone 11. Specifically, as described above, if the telephone number of the IP telephone 12 extracted from the INVITE packet is registered in the telephone number management table, it is judged that the IP telephone 12 is connected to the same network as the IP telephone 11.

Here the IP telephone 12 is connected to the IP network 1, so the IP telephone is registered in the telephone number management table of the GW 10. Therefore the GW 10 judges that the IP telephone 12 is connected to the same network as the IP telephone 11.

In this case, the GW 10 refers to the telephone number management table, and acquires the IP address of the IP telephone 12 which is registered therein.

Then the GW 10 refers to its own ARP table, and acquires the MAC address of the IP telephone 12. If the MAC address of the IP telephone 12 is not registered in the ARP table, the GW 10 sends the ARP request packet to the IP network 1 to which the GW 10 and IP telephone 12 are connected based on the IP address of the IP telephone 12, and acquires the MAC address of the IP telephone 12 as the response.

Then the GW 10 sets the IP address of the IP telephone 12 to the destination IP and generates the INVITE packet, and sets the MAC address of the IP telephone 12 to the destination MAC, and sends the INVITE packet to the IP telephone 12.

When the INVITE packet is received from the GW 10, the IP telephone 12 calls up the user by ringing a bell, for example. When the user answers the call up, the IP telephone 12 sets the IP address of the IP telephone 11 to the destination IP, generates the OK packet, sets the MAC address of the GW 10 to the destination MAC, and sends the OK packet to the GW 10.

When the OK packet is received, the GW 10 transfers this to the IP telephone 11.

When the OK packet is received from the GW 10, the IP telephone 11 sets the IP address of the IP telephone 12 to the destination IP, generations an ACK packet, sets the MAC address of the GW 10 to the destination MAC, and sends the ACK packet to the GW 10.

When the ACK packet is received, the GW 10 transfers this to the IP telephone 12.

By the above sequence, the session is established between the IP telephone 11 and the IP telephone 12 via the GW 10.

After the session is established, the GW 10 controls such that the voice packets are directly transmitted and received between the IP telephone 11 and the IP telephone 12, so that routing on this session is not generated in the GW 10.

Specifically the GW 10 sends a packet, to instruct to send voice packets directly to the call destination, to the IP telephone 11 and the IP telephone 12.

When this instruction packet is received, the IP telephone 11 changes the transmission destination of the voice packets on this session to the IP telephone 12, not to GW 10.

Specifically, the IP telephone 11 converts the voice signals corresponding to voice spoken by the user into digital data, sets the IP address of the IP telephone 12 to the destination IP, generates the voice packets, sets the MAC address of the IP telephone 12 to the transmission destination MAC, and sends the voice packets to the IP telephone 12. After the session is established, the IP telephone 11 can know the IP address of the IP telephone 12, so the IP telephone 11 can refer to its own ARP table and acquire the MAC address of the IP telephone 12. If the MAC address of the IP telephone 12 is not registered in the ARP table, the IP telephone 11 sends the ARP request packet to the IP network 1, to which the IP telephone 11 and the IP telephone 12 are connected, based on the IP address of the IP telephone 12, and acquires the MAC address of the IP telephone 12 as the response.

When the voice packets are received from the IP telephone 11, the IP telephone 12 adjusts the restoring sequence based on a time stamp and sequence number in the packet header, restores the digital data in the voice packets to analog voice signals, and outputs them.

The sequence when voice packets are sent from the IP telephone 12 to the IP telephone 11 is also the same.

The session is ended by one IP telephone sending the BYE packet to indicate the end of the session to the remote side via the GW 10, and receiving the response packet to the BYE packet from the remote side via the GW 10.

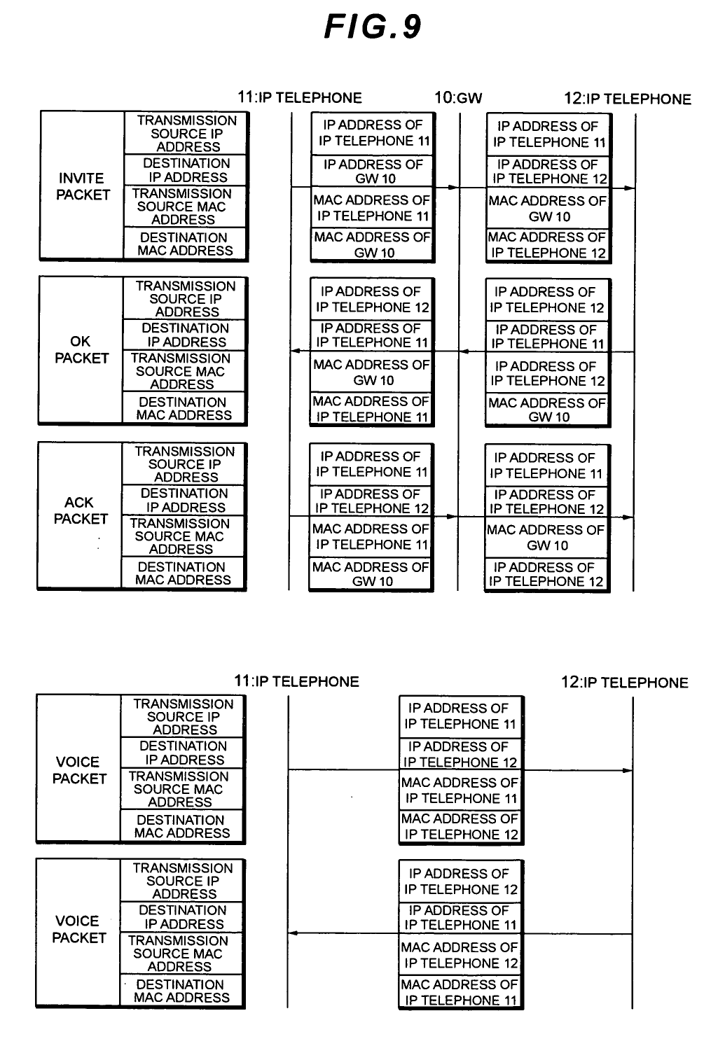

FIG. 9 shows the IP address and MAC address to be set for each INVITE packet, OK packet, ACK packet and voice packet to be transmitted/received in the above sequence.

In the case when the session is a session within a same IP network, as described above, the voice packets are directly transmitted and received between the IP telephones, so the GW 10 need not perform routing processing (transfer processing) of the voice packets on this session, and the load related to the routing processing (not only the processing volume of the CPU but the load of the all system resources, such as the memory area to be used for routing), can be decreased considerably. As a result, the number of sessions that can be simultaneously established per predetermined specification can be increased in the GW 10, and the performance of the gateway can be improved.

In the first example, packets on the session are transmitted/received via the GW 10, so the GW 10 can function as a call stateful GW, which can manage the information of the session and can know the presence of each IP telephone and talking time. Therefore the GW 10 can implement various functions, including incoming representation, just like the case when the session extends over a plurality of IP networks.

### SECOND EXAMPLE

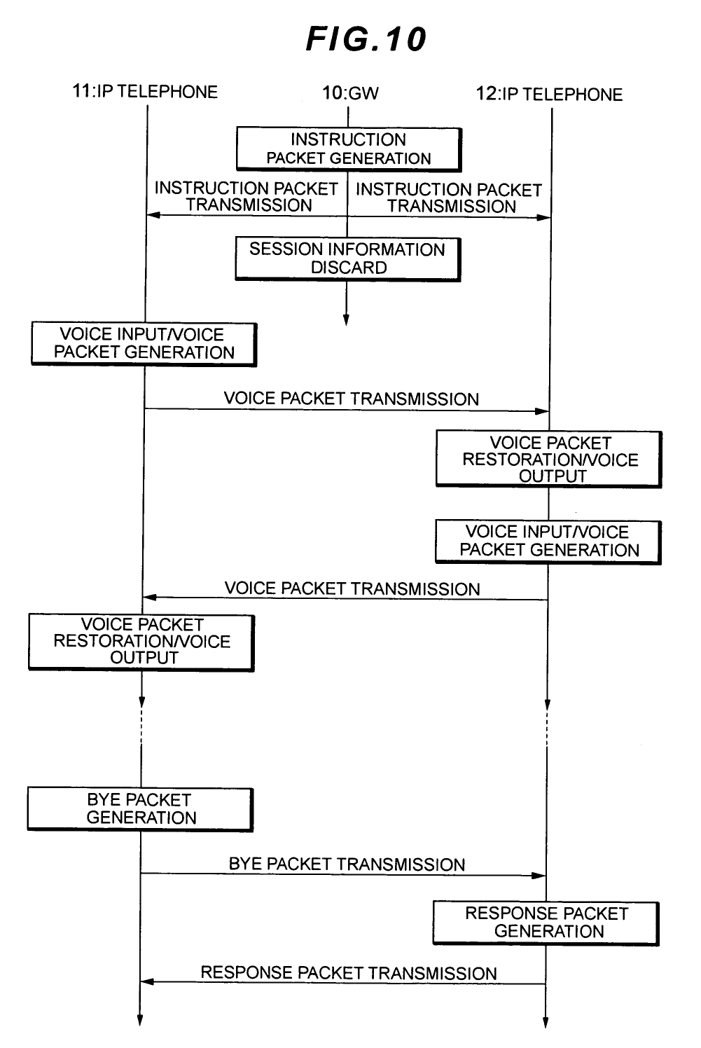

A sequence when a session is established via the GW 10, then voice packets and packets on the session are directly transmitted and received between the IP telephones, will be described as a second example (see FIG. 7 and FIG. 10).

The sequence until the session is established between the IP telephone 11 and the IP telephone 12 via the GW 10 is the same as the first example shown in FIG. 7.

After the session is established, the GW 10 controls so that the voice packets and packets on the session are directly transmitted and received between the IP telephones.

Specifically, the GW 10 sends a packet, to instruct to send voice packets and packets on the session directly to the call destination, to the IP telephone 11 and IP telephone 12. When the response to this instruction packet is received, the GW 10 discards information on the session between the IP telephone 11 and IP telephone 12.

The sequence of the IP telephone 11 and the IP telephone 12 when this instruction packet is received is the same as the first example.

The session is ended, however, by one IP telephone directly sending the BYE packet to indicate the end of the session to the remote side and directly receiving the response packet to the BYE packet from the remote side, since it is instructed that packets on the session are also transmitted and received between the IP telephones directly.

In the case of the second example, the voice packets are directly transmitted and received between the IP telephones, just like the first example, so the load related to routing processing on the GW 10 can be decreased considerably.

Also in the second example, not only the voice packets but also the packets on the session are also transmitted and received between the IP telephones directly, so the load related not only to routing processing but also to session management on the GW 10 can be decreased.

### THIRD EXAMPLE

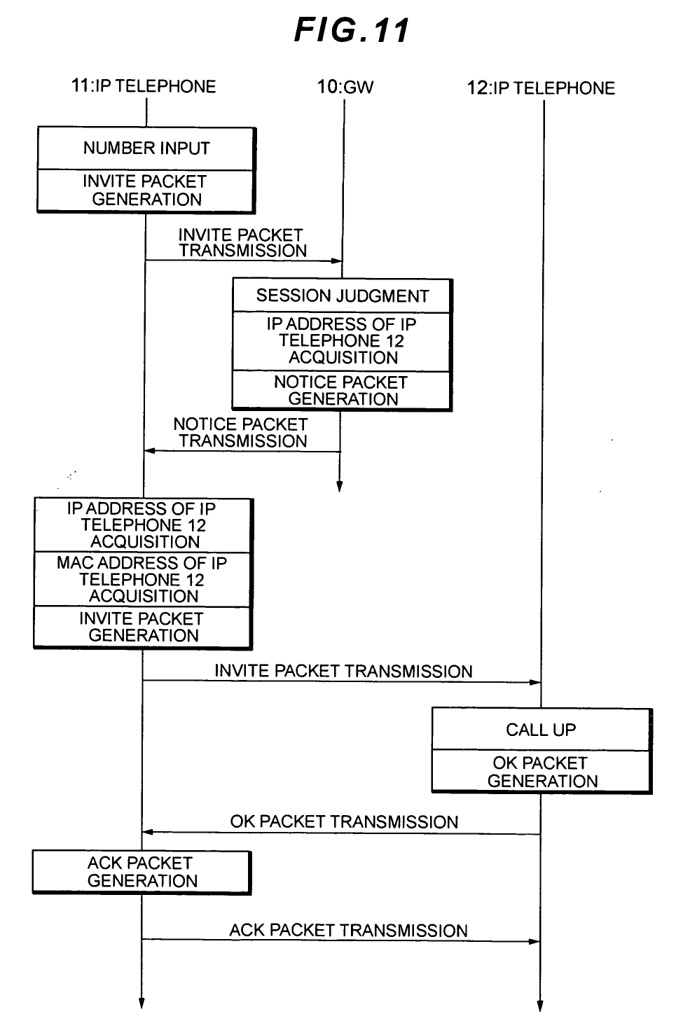

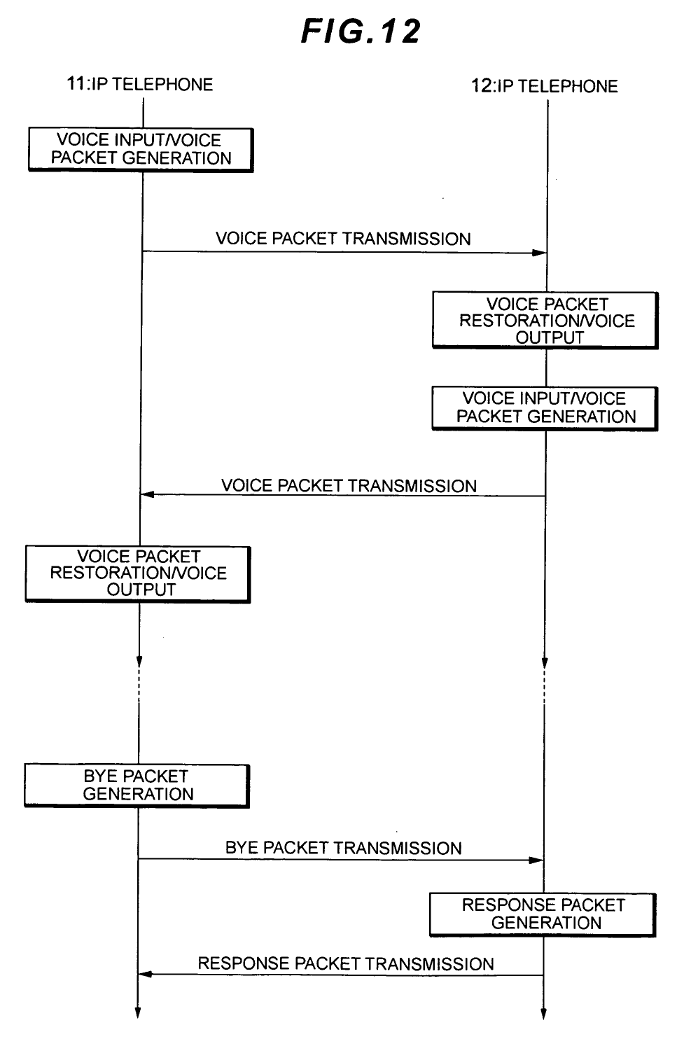

A sequence when a session is directly established between the IP telephones without establishing a session via the GW 10 will be described as a third example (see FIG. 11 and FIG. 12).

The user inputs the telephone of the IP telephone 12, which is the call destination, to the IP telephone 11.

Receiving this, the IP telephone 11 sets the IP address of the GW 10 as the destination IP, and generates the INVITE packet for storing the telephone number of the IP telephone 12 as data.

Then the IP telephone 11 sets the MAC address of the GW 10 to the destination MAC, and sends the INVITE packet to the GW 10.

When the INVITE packet is received from the IP telephone 11, the GW 10 judges whether this session is a session within the IP network 1, that is whether the IP telephone 12 at the call destination is connected to the same IP network of the IP telephone 11. Specifically, as described above, the telephone number of the IP telephone 12 is extracted from the INVITE packet. And the telephone number management table on the IP network 1 is referred to, and if the extracted telephone number is registered in the telephone number management table, it is judged that the IP telephone 12 is connected to the same network as the IP telephone 11.

Here the IP telephone 12 is connected to the IP network 1, so the IP telephone 12 is registered in the telephone number management table of the GW 10. Therefore the GW 10 judges that the IP telephone 12 is connected to the same network as the IP telephone 11.

In this case, the GW 10 refers to the telephone number management table, and acquires the IP address of the IP telephone 12 which is registered therein.

Then the GW 10 sends the notification packet for storing the IP address of the IP telephone 12 (as the contact header, for example) to the IP telephone 11, so that voice packets are directly transmitted and received between the IP telephones. This notification packet may be a response packet to the INVITE packet, and in this case a packet to indicate such as response as “Not Acceptable” can be used.

The IP telephone 11 receives this notification packet, and acquires the IP address of the IP telephone 12 to be stored in the notification packet.

Then the IP telephone 11 sets the IP address of the IP telephone 12 to the destination IP, and generates the INVITE packet, and sets the MAC address of the IP telephone 12 to the destination MAC and sends the INVITE packet to the IP telephone 12. Just like the first example, the IP telephone 11 can acquire the MAC address of the IP telephone 12 by referring to the ARP table or by sending an ARP request.

When the INVITE packet is received from the IP telephone 11, the IP telephone 12 calls up the user by ringing a bell, for example. When the user answers the call up, the IP telephone 12 sets the IP address of the IP telephone 11 to the destination IP, generates the OK packet, sets the MAC address of the IP telephone 11 to the destination MAC, and sends the OK packet to the IP telephone 11. The IP telephone 12 can know the MAC address and IP address of the IP telephone 11 as the transmission source MAC address and transmission source IP address of the received INVITE packet.

When the OK packet is received from the IP telephone 12, the IP telephone 11 sets the IP address of the IP telephone 12 to the destination IP, generates an ACK packet, sets the MAC address of the IP telephone 12 to the destination MAC, and sends the ACK packet to the IP telephone 12.

By the above sequence, a session is directly established between the IP telephone 11 and the IP telephone 12 without going through the GW 10.

After the session is established, the IP telephone 11 converts the voice signals corresponding to the voice spoken by the user into digital data, sets the IP address of the IP telephone 12 to the destination IP, generates the voice packets, sets the MAC address of the IP telephone 12 to the destination MAC, and sends the voice packet to the IP telephone 12.

When the voice packets are received from the IP telephone 11, the IP telephone 12 adjusts the restoring sequence based on the time stamp and sequence number in the packet header, restores the digital data in the voice packets to analog voice signals, and outputs them.

The sequence when voice packets are sent from the IP telephone 12 to the IP telephone 11 is also the same.

The session is ended by one IP telephone directly sending the BYE packet to indicate the end of the session to the remote side, and directly receiving the response packet to the BYE packet from the remote side.

In the case of the third example, the voice packets are directly transmitted and received between the IP telephones, just like the first example, so the load related to the routing processing on the GW 10 can be decreased considerably.

Also in the third example, the session is also established directly between the IP telephones, so not only the load related to routing processing but also the load related to the establishment of the session and the management of session information on GW 10 can also be decreased.

(Other)

The present invention is not limited to the above embodiments, but can be applied to various modifications.

For example, the operation mode of the gateway device described in the above embodiment concerns when a session start request to the second terminal device is accepted from the first terminal device, the routing processing is executed if the session extends over a plurality of IP networks, and the routing avoidance processing is executed if the session is a session within a same IP network, but the operation mode where routing processing is always executed regardless the status of the session, or the operation mode where routing avoidance processing is executed regardless the status of the session may be selected and set.

For example, if the IP network 1 is constructed as an extended network, and if the number planning, where the extension can be identified from a regular line, is used, the GW 10 can judge whether the session is a session within a same IP network based on this number planning, without confirming the registration of the telephone numbers by referring to the telephone number management table in the GW 10.

Whether the session is a session within a same IP network or not may be judged by inquiring the location server first, and acquiring the IP address of the call destination, and comparing the network address of the IP address at the calling side and the IP address at the call destination.

What is claimed is:

1. A gateway device, comprising:
means for judging whether a first terminal device and a second terminal device are connected to a same network, as an operation mode when a session start request from the first terminal device to the second terminal device is accepted;
means for routing packets transmitted or received between the first terminal device and the second terminal device when both of the terminal devices are not connected to a same network; and
means for performing control such that packets are directly transmitted or received between the first terminal device and the second terminal device when both of the terminal devices are connected to a same network, so that routing related to the session is not generated.

2. The gateway device according to claim 1, further comprising means for managing information of the session between the first terminal device and the second terminal device when a session start request from the first terminal device to the second terminal device is accepted.

3. The gateway device according to claim 1, wherein the packet directly transmitted or received between the first terminal device and the second terminal device includes at least one of a voice packet and a packet related to the session, when both of the terminal devices are connected to a same network.

4. The gateway device according to claim 1, further comprising means for establishing the session between the first terminal device and the second terminal device via the gateway device, when a session start request from the first terminal device to the second terminal device is accepted.

5. The gateway device according to claim 1, further comprising means for performing control such that a direct session is established between the first terminal device and the second terminal device without establishing the session via the gateway device when both of the terminal devices are connected to a same network.

6. A method for controlling a gateway device, comprising the steps of:
accepting a session start request from a first terminal device to a second terminal device;
judging whether the first terminal device and the second terminal device are connected to a same network;
routing packets transmitted or received between the first terminal device and the second terminal device when both of the terminal devices are not connected to a same network; and
performing control such that packets transmitted from one of the first terminal device and the second terminal device can be directly received by the first terminal device or the second terminal device, when both of the terminal devices are connected to a same network, so that routing related to the session is not generated.

7. A computer program product, comprising a computer program for causing a gateway device to execute the control method according to claim 6.
